(19) United States
(12) Patent Application Publication
(10) Pub. No.: US 2025/0297884 A1
(43) Pub. Date: Sep. 25, 2025

(54) KIT OF COMPONENTS FOR FORMING AN INTERCHANGEABLE HOPPER FOR BATCHING/WEIGHING PRODUCTS IN A COMBINED WEIGHING APPARATUS

(71) Applicant: ILAPAK ITALIA S.P.A., FOIANO DELLA CHIANA (AR) (IT)

(72) Inventors: Stefano ROLLERI, FOIANO DELLA CHIANA (AR) (IT); Paolo MARINI, FOIANO DELLA CHIANA (AR) (IT); Davide GRAZIANI, FOIANO DELLA CHIANA (AR) (IT)

(73) Assignee: ILAPAK ITALIA S.P.A., FOIANO DELLA CHIANA (AR) (IT)

(21) Appl. No.: 18/861,609

(22) PCT Filed: May 2, 2023
(86) PCT No.: PCT/IB2023/054545

§ 371 Date: Oct. 30, 2024

(30) Foreign Application Priority Data
May 3, 2022 (IT) 102022000008882

(51) Int. Cl. G01G 13/06

(52) U.S. Cl. CPC G01G 13/06

(57) ABSTRACT

The kit of components for forming an interchangeable batching/weighing hopper for batching/weighing products in a combined weighing apparatus comprises a first common component, mountable on the weighing apparatus, and at least one unit of interchangeable second components comprising a hollow box body and a hatch which are assemblable and mountable on the first common component to form the hopper.

### FIELD OF THE INVENTION

The present invention concerns the technical sector relating to automatic weighing of products, for example, though not exclusively, food products, being fresh vegetables, cooked or frozen vegetables, biscuits, sweet foods, snacks, frozen products, etc., which are to be sorted and then packaged internally of relative packages once having reached a predetermined overall weight, for example an overall weight comprised within a determined range.

In particular, the present invention concerns a kit of components for forming an interchangeable hopper for batching/weighing products in a combined weighing apparatus.

### DESCRIPTION OF THE PRIOR ART

FIG. 1A illustrates a type of combined weighing apparatus (A) for automatic weighing of products, such as, for example, food products, which are to be sorted and then packaged internally of a relative package once having reached a predetermined overall weight.

This apparatus (A) comprises a main structure (A1), of the carousel type, on which a first series of batching hoppers (D) are circumferentially mounted, which are destined to receive, and temporarily store internally thereof, products in arrival from a feeder (not illustrated in FIG. 1A) arranged superiorly, and which are then distributed and conveyed internally of the batching hoppers (D) by a distribution system with channels (SD).

This apparatus (A) further comprises a second series of weighing hoppers (P), also mounted circumferentially on the main structure (A1), in a lower position with respect to the batching hoppers (D).

The weighing hoppers (P) are destined to receive the products from the overlying batching hoppers (D) and carry out the weighing thereof by means of corresponding load cells associated thereto.

When the combination (sum) of weights of the products present internally of a given number of weighing hoppers (P) reaches a predetermined overall weight value of products, being, for example, contained within a predetermined reference range, corresponding to the quantity of products which are to be sorted and then packaged internally of a relative package, the weighing hoppers (P) unload the products contained therein onto respective conveyor slides (T) which direct the products internally of an unloading hopper(S) for the unloading of the products into the package.

When a given number of weighing hoppers has unloaded the relative contents, then the batching hoppers overlying them in turn unload the products that in the meantime have accumulated in the underlying weighing hoppers.

Document EP 3 767 254 describes batching/weighing hoppers which are usually utilised in combined weighing apparatus of the type described in the foregoing.

The hoppers (D, P) described in EP 3 767 254 are made in the following way, as illustrated in FIG. 1B.

The hoppers (D, P) comprise:

a frame (F), for example constituted by brackets provided with hooking and coupling elements, for the anchoring of the hoppers to the supporting structure (A1) of the apparatus (A);

a hollow box body (B), substantially constituted by metal sheets, for example stainless steel, fashioned by mutual bending to form a receptacle with inclined walls which is rigidly and unremovably anchored, for example by welding, to the frame (F) so as to form a single body with the frame (F), and which is provided with an upper opening (I), for receiving the products, and a lower opening (O), for the unloading of the products;

at least one hatch (G) which is hinged to at least a wall of the hollow box body (B) and activatable in rotation about the relative hinge axis with respect to the hollow box body (B) by means of a mechanism (N) constituted by an assembly of levers, mounted on the frame (F) or borne by the supporting structure (A1) of the apparatus (A), in order to close or open the lower opening (O) of the hollow box body (B), and thus enable retaining the products internally of the hollow box body (B) or enable unloading thereof.

The batching/weighing hoppers, structured in this way, have some drawbacks, mainly dictated by the fact that the hollow box body, forming the storage receptacle for the products, is in a single body with the frame, as it is rigidly and unremovably fixed thereto by welding.

In a case where the weighing apparatus is to treat products of different types, and therefore having different shapes, dimensions and weights, the batching/weighing hoppers must have a shape and capacity that are adequate for the particular type of products, and thus have a hollow box body dimensioned appropriately and with a determined capacity (or volume).

In these cases, at present, it is necessary to proceed to the dismounting of the whole structure of the hoppers, and thus to the removal of the frame with the relative hollow box body fixed thereto, from the supporting structure, and proceed to the replacement thereof with other hoppers having a box body adequate for the products to be weighed, borne, since they are fixed, by a respective frame.

It is therefore necessary to have available a considerable stock of hoppers of different dimensions, and therefore each with a frame and relative box body, with the articulated hatch, fixed thereto, appropriately dimensioned, and possibly also the relative mechanism for activation of the frame.

The internal walls of the hollow box body, as well as the hatch, are those parts destined for contact with the products, and in the case of food products, often, and according to the type of products, must be subjected to special treatments, for example anti-adherence treatments.

To carry out these treatments, it is necessary to proceed to the dismounting of the whole structure of the hoppers, and therefore also of the frame and of the movement mechanism of the hatch.

The treatments can compromise the anchoring by welding of the hollow box body to the frame, as well as the movement mechanism of the hatch.

In these circumstances, it is necessary to proceed to the replacement of the whole structure of the hopper, and therefore the frame and the relative hollow box body with the hinged hatch.

Also, in the event of wear or deterioration of the hollow box body or the hatch hinged thereto, it will be necessary to proceed with the removal of the whole structure of the hopper, and therefore also of the frame and of the movement mechanism of the hatch, incurring not insignificant costs.

### SUMMARY OF THE INVENTION

The aim of the present invention is therefore to describe a kit of components for forming an interchangeable hopper for batching/weighing products in a combined weighing apparatus able to obviate the above-mentioned drawbacks.

In particular, an aim of the invention is to provide a kit of components which are mutually assemblable and couplable in such a way as to be able to form, time by time and according to needs, hoppers of varying capacity, or allow replacement, in a simple and immediate way, of only components that are worn or are to be subjected to special treatments.

The above aims are attained in accordance with the claims.

### DESCRIPTION OF THE DRAWINGS

The characteristics of a preferred, but not exclusive, embodiment of the kit of components for making up an interchangeable hopper for the batching/weighing of products in a combined weighing apparatus, object of the present invention will be revealed in the following description with reference to the appended tables of drawings, in which:

FIG. 1A, already mentioned in the foregoing, illustrates, according to a schematic front view, a combined weighing apparatus, utilising a series of batching and weighing hoppers for automatic weighing of products to be inserted in relative packages once a predetermined weight has been reached;

FIG. 1B, also already mentioned in the foregoing, illustrates the structure of a batching/weighing hopper of the prior art described in cited document EP 3 767 254;

FIG. 2A illustrates, in a schematic and perspective view,-a first significant component of the kit of components for forming the interchangeable hopper of the present invention;

FIG. 2B is a plan view from above view of the first component of the kit of FIG. 2A;

FIG. 2C is a lateral view of the first component of the kit of FIG. 2A;

FIG. 2D is a front posterior view of the first component of the kit of FIG. 2A;

FIG. 3A illustrates, in a schematic and perspective view,-a group of second components of the kit that are assemblable and couplable with the first component of the kit so as to make up the interchangeable batching/weighing hopper of the present invention;

FIG. 3B is a plan view from above view of the unit of second components of the kit of FIG. 3A; 5

FIG. 3C is a lateral view of the unit of second components of the kit of FIG. 3A;

FIG. 3D is a front posterior view of the unit of second components of the kit of FIG. 3A;

FIG. 4A is a schematic perspective view of the first component of the kit and the unit of second components of the kit, neared to one another and prior to the assembling thereof;

FIG. 4B is a lateral view of the first component of the kit and the unit of second components of the kit of FIG. 4A, neared to one another and prior to the assembling thereof;

FIG. 4C is a plan view from above of the first component of the kit and the unit of second components of the kit of FIG. 4A, neared to one another and prior to the assembling thereof;

FIG. 4D is a front posterior view of the first component of the kit and the unit of second components of the kit of FIG. 4A, neared to one another and prior to the assembling thereof;

FIG. 5A illustrates, in a schematic perspective view, the first component of the kit and the unit of second components of the kit assembled to one another and coupled so as to make up an interchangeable hopper for batching/weighing;

FIG. 5B is a lateral view of the first component of the kit and the unit of second components of the kit assembled to one another and coupled so as to make up an interchangeable hopper for batching/weighing;

FIG. 5C illustrates, in a in plan view from above, the first component of the kit and the unit of second components of the kit assembled to one another and coupled so as to make up an interchangeable hopper for batching/weighing;

FIG. 5D is a front posterior view of the first component of the kit and the unit of second components of the kit assembled to one another and coupled so as to make up an interchangeable hopper for batching/weighing.

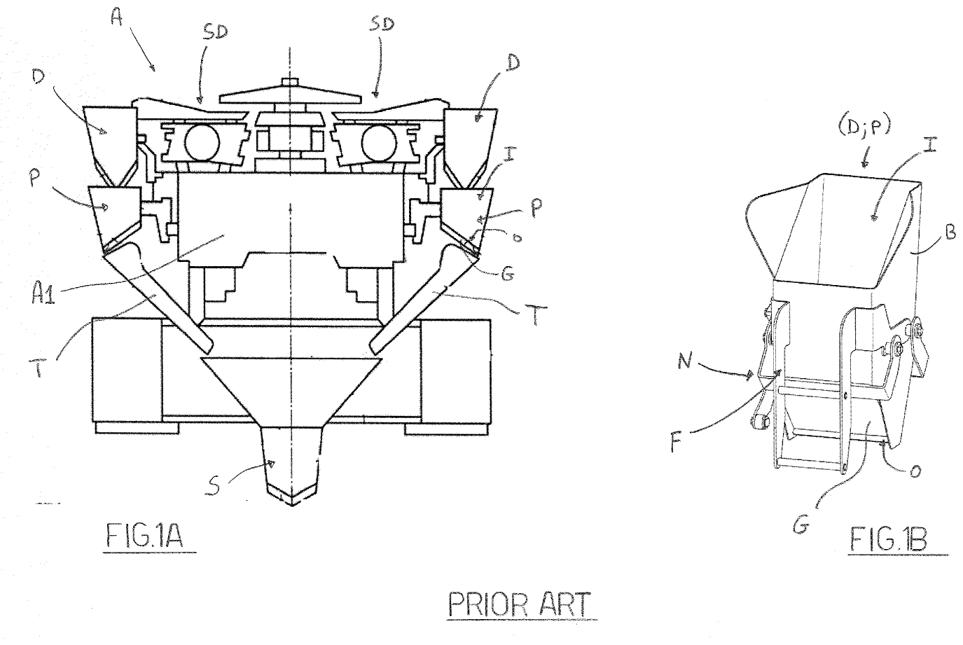

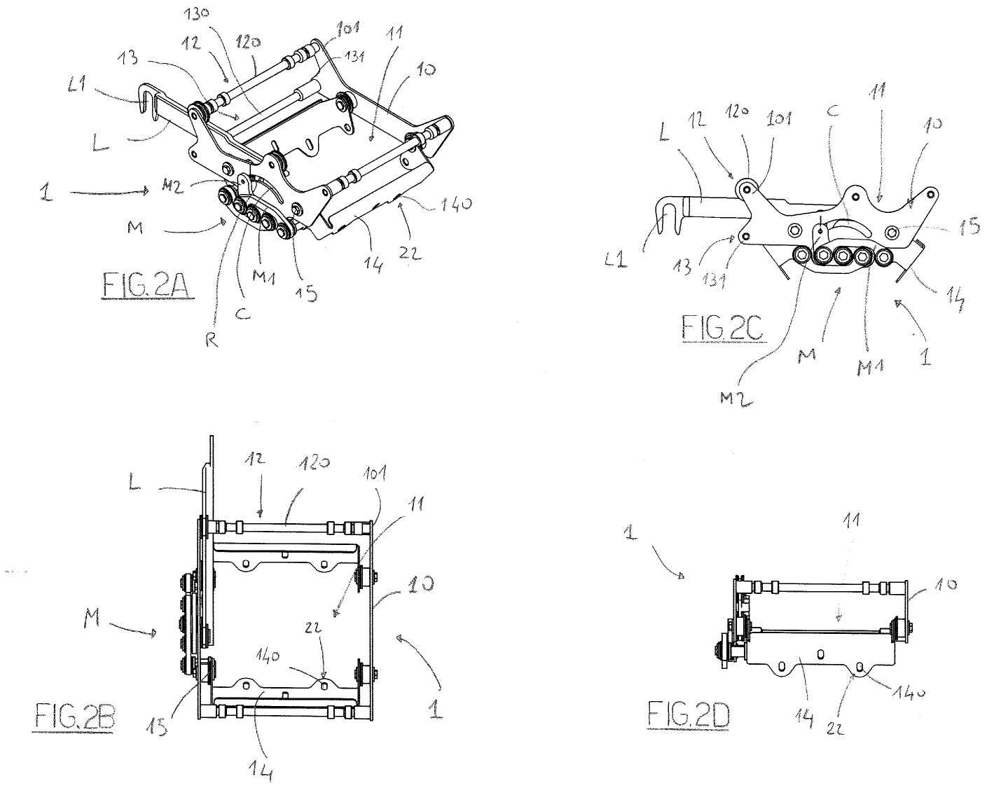

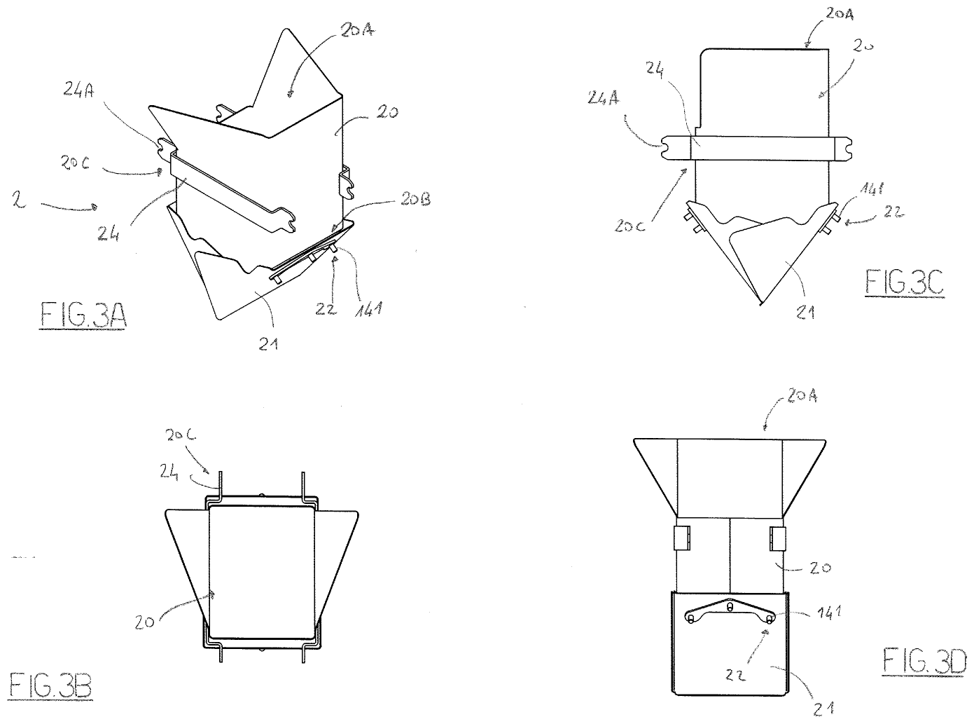

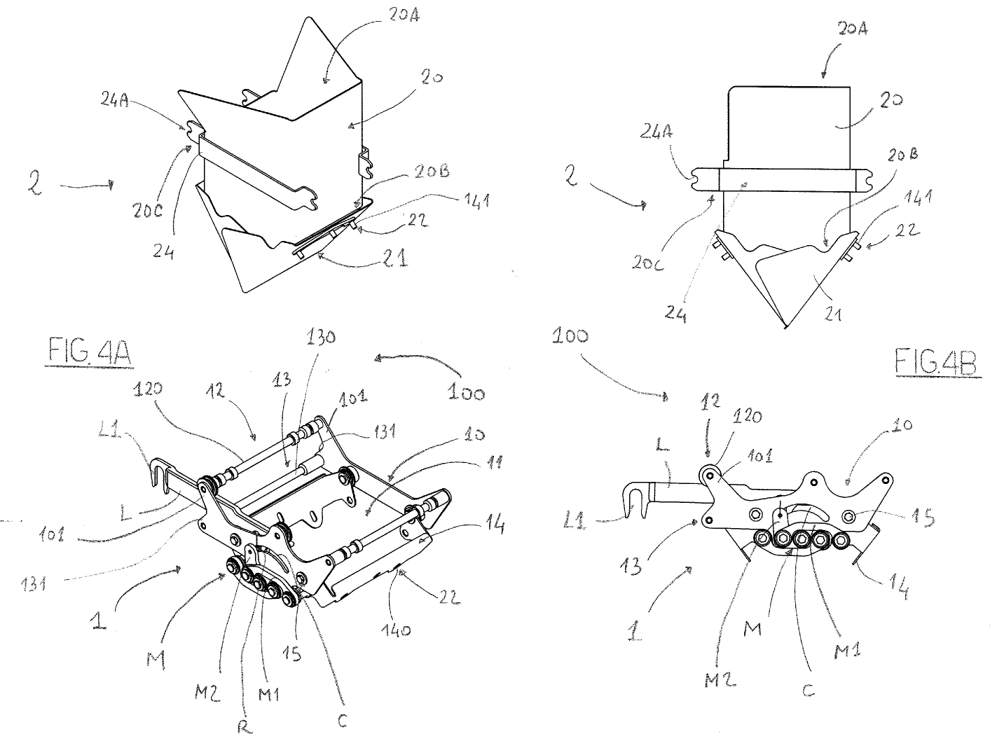

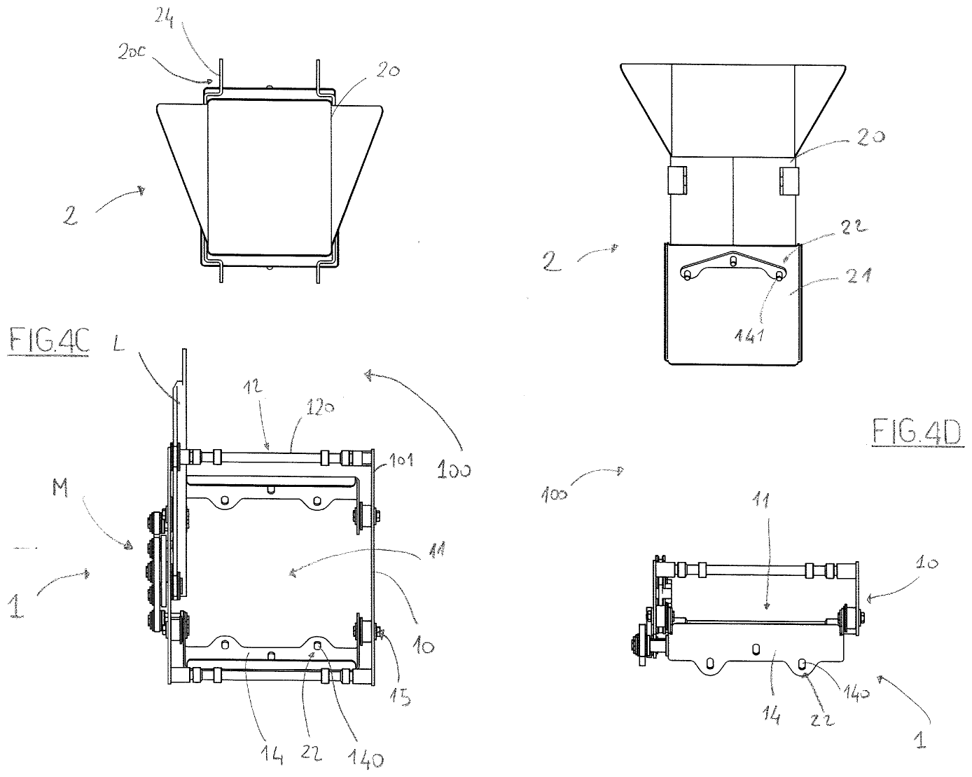

### DESCRIPTION OF THE PREFERRED EMBODIMENTS

With reference to the accompanying tables of drawings, in particular to figures from 2A to 5D, reference numeral (100) relates to the kit of components for forming an interchangeable batching/weighing hopper for batching/weighing products in a combined weighing apparatus, object of the present invention, in its entirety.

The kit (100) comprises a first common component (1), which is structured and configured to be mountable on a supporting structure of a combined weighing apparatus, and at least one unit (2) of interchangeable second components (20, 21), which are configured and conformed in such a way as to be assemblable and mountable on the first common component (1) so as to make up a batching/weighing hopper (TD) for a combined weighing apparatus of products, for example, though not exclusively, food products, being fresh vegetables, cooked or frozen vegetables, biscuits, sweet foods, snacks, frozen products, etc., which are to be sorted and then packaged internally of relative packages once having reached a predetermined overall weight.

The components of the kit of the invention are made in the following way.

The first common component (1) comprises (see for example figures from 2A to 2D):

a frame (10) which is conformed in such a way as to define a seat (11);

at least one coupling and fixing member (13) borne by the frame (10), for mounting and anchoring the frame (10) to a portion of the supporting structure of the combined weighing apparatus;

at least one movable element (14) articulated to the frame (10) according to an axis of articulation (15) transverse to the seat (11);

a driving mechanism (M) for rotational actuation of the movable element (14) about the respective axis of articulation (15) comprising an actuation lever (L) having an end (L1) configured so as to be couplable to and operable by a respective actuating member mounted on the supporting structure of the weighing apparatus.

For example, the frame (10) can be formed by an assembly of metal profiled members arranged so as to define between them a seat (11).

The coupling and fixing member (13) is conformed and configured to be able to couple with a respective housing usually present in the supporting structure of the weighing apparatus.

The unit (2) of interchangeable second components (20, 21) comprises (see for example figures from 3A to 3D):

a hollow box body (20) having an upper opening (20A) and a lower opening (20B), and dimensioned to be inserted in the seat (11) of the frame (10); at least one hatch (21).

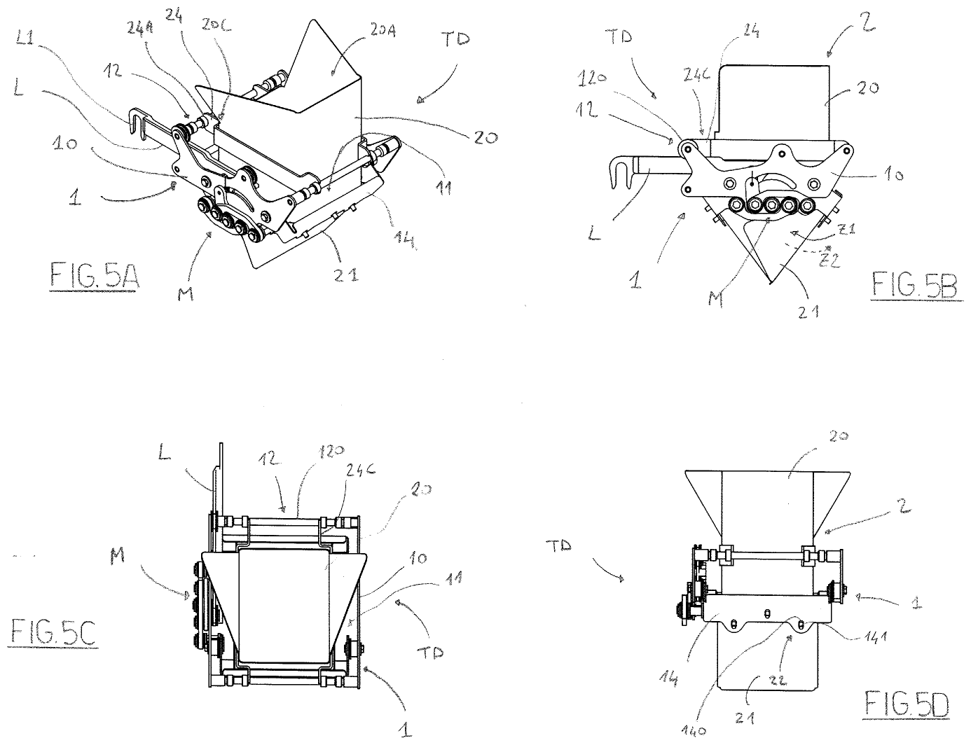

In particular, the hatch (21) is conformed in such a way as to open the lower opening (20B) of the hollow box body (20) when the driving mechanism (M) rotates the movable element (14) about the respective axis of articulation (15) in a first direction of rotation (Z1), and in such a way as to open the lower opening (20B) of the hollow box body (20) when the driving mechanism (M) rotates the movable element (14) about the respective axis of articulation (15) in a second direction of rotation (Z2) (see for example FIG. 5B).

In greater detail, the hollow box body (20) comprises at least one hooking element (20C) which is conformed so as to couple removably with at least one support element (12) of the frame (10), in such a way as to maintain the hollow box body (20) positioned stably in the seat (11) of the frame (10), and with the at least one hatch (21) which is configured and dimensioned so as to couple via the hooking means (22) removably to the at least one movable element (14) articulated to the frame (10).

For example, the hollow box body can be formed by metal sheeting, for example stainless steel, fashioned by bending to form a receptacle with inclined walls having an upper opening, for receiving the products, and a lower opening for unloading the products.

In this way, by inserting the hollow box body (20) into the seat (11) of the frame (10) of the first common component (1), by coupling the hooking element (20C) of the hollow box body (20) with the support element (12) of the frame (10), and coupling the hatch (21) to the movable element (14) articulated to the frame (10), its is possible to make up a hopper (TD) to be used as a batching/weighing hopper in a combined weighing apparatus of products to be inserted into a respective package (see for example figures from 5A to 5D).

The hollow box body and the hatch can then be, independently of one another, mounted to and dismounted from the frame in a simple and rapid way.

Therefore with the kit of the invention it is possible to have a first common component on which, time by time, a hollow box body and a hatch can be mounted and coupled, the hatch being for the opening and closing of the lower opening of the hollow box body, so as to make up a batching/weighing hopper. Thus, in a case where the weighing apparatus is to treat products of different types (in terms of shape, dimensions, weight), with the kit of the invention it will be sufficient to dismount the hollow box body and the hatch from the frame of the first common component and mount on the frame another hollow box body and relative hatch having the dimensions, and therefore a corresponding capacity, adequate for the various type of products to be treated.

Further, in a case where the hollow box body and/or the relative hatch of a particular hopper mounted on the weighing apparatus are worn, it will be sufficient to dismount the hollow box body and/or the hatch from the frame of the first common component and replace them with other new components (hollow box body and hatch).

The replacement can also regard only the hollow box body or only the hatch. Also when the various hoppers mounted on the weighing apparatus are to be subjected to special treatments in relation to the nature and type of products to be treated, it will be sufficient to dismount the respective hollow box bodies and hatches from the various frames of the various first common components, and subject them to the treatments and, once the treatments have been concluded, to remountle them on the frames of the first common components. Therefore, with the kit of components of the present invention it is possible to form, time by time, according to the various needs, weighing/batching hoppers of various dimensions and capacities, dismount only the parts (hollow box body and/or hatch) destined to be subjected to special treatments and then remounted, remove the worn parts (hollow box body and/or hatch) in order to replace them with others, all the time using a first supporting common component, couplable to the structure of the weighing apparatus, and a second unit of components (box body, hatch) constituting replacement parts utilisable for the formation of the receptacle of the hopper with the relative closing/opening hatch.

Therefore, the kit of components of the invention is able to obviate the drawbacks now present with the use of batching/weighing hoppers as described in the preamble and illustrated in document EP 3 767 254.

Further, it will be possible to apply a MOCA CE 1935/2004 mark on every single component of the kit, such as for example on the frame of the first common component, as well as on the various hollow box bodies and on the various hatches which time by time are mounted on the frame of the first common component.

Other special characteristics of the kit of components of the invention are described in the following.

The at least one support member (12) mounted on the frame (10) is constituted by a first bar (120) mounted on a facing first pair of arms (101), while the at least one hooking element (20C) of the hollow box body (20) can be constituted by at least one bracket (24) having an end (24A) shaped so as to be removably couplable with the first bar (120).

Other arrangements can be included for realising a removable coupling between the hollow box body and the frame of the first common component. On the basis of the preferred but not exclusive embodiment, illustrated in the figures, the hooking means (22) for removably attaching the at least one hatch (21) to the at least one movable element (14) articulated to the frame (10) of the first common component (1) can be realised in such a way as to comprise at least one through-hole (140) made in the movable element (14) and at least one tang element (141) protruding externally from the at least one hatch (21) which is dimensioned and shaped so as to insert in the through-hole (140) of the movable element (14) in such a way as to enable a removable coupling between the at least one hatch (21) and the at least one movable element (14) of the frame (10) (for example by nuts or other blocking elements).

In this case too, other arrangements can be included for realising a removable attachment of the hatch to the movable element of the frame of the first common component.

The driving mechanism (M) for rotational actuation of the movable element (14) about its respective axis of articulation (15) can be made in such a way as to comprise a first arm (M1) connected at one end to the axis of articulation (15) of the movable element (14), and a second arm (M2) articulated to the first arm (M1) and articulated by means of a roller (R) to the actuation lever (L), with the roller (R) being slidable within a sliding slot (C) formed in a portion of the frame (10) of the first common component (1).

The movement mechanism (M) can also be realised using a different manufacturing method, using a different arrangement or number of arms and/or levers, which is however within the knowledge of a technical expert in the sector.

The at least one coupling and fixing member (13) of the first common component (1) for mounting and anchoring the frame (10) to a portion of the supporting structure of the combined weighing apparatus, can preferably be constituted by a second bar (130) mounted between a second pair of arms (131) conformed by the frame (10) of the first common component (1).

In this case, the second bar can be positioned in a corresponding housing of the supporting structure of the weighing apparatus and coupled and fixed thereto.

As previously mentioned, the unit (2) of interchangeable second components (20, 21) to be coupled and assembled to the first common component (1) can be selected from at least two units (2) of second components (20, 21), wherein a first unit (2) of second components (20, 21) comprises a first hollow box body (20) with a respective first hooking element (20C) and a second unit (2) of second components (20, 21) comprising a second hollow box body (20) with a respective second hooking element (20C), the first and second hollow box body (20) being dimensioned in such a way as to have respectively a predetermined first and a second capacity different to one another.

The first and second hollow box component (20) are insertable in the seat (11) of the frame (10) of the first common component (1) so that the respective first or second hooking element (21C) removably couples with the support element (12) of the frame (10), with at least one respective first or second hatch (21) being dimensioned so as to be able to respectively occlude or open the lower opening of first or second hollow box body (20) coupled to the movable element (14) of the frame (10) of the first common component (1).

In particular, the first and second hooking element (21C) are configured and dimensioned so as to couple alternatively and removably with at least one support element (12) of the frame (10) in a same point. Figures from 4A to 4D illustrate the components of the kit of the invention (first common component and the units of second components comprising the hollow box body and at least a respective hatch) in a configuration moved towards one another before the reciprocal assembly.

In these figures, and also in figures from 3A to 3D, the hatch is illustrated already neared to the box-shaped body, in reality, as is also clear from the preceding description, the hatch is an independent component with respect to the box-shaped body.

The units of second components can also comprise a second hatch mountable on a second movable element articulated to the frame.

The use of single hatch, or a pair of hatches, also depends on the shape and dimensions of the hollow box body, and therefore of the hopper that is to be made up and obtained.

Therefore, with the kit of components of the invention it is possible to form a hopper using components, which together define the receptacle for receiving the products, which are interchangeable with one another.

The interchangeable batching/weighing hopper (TD) for batching/weighing products in a combined weighing apparatus which is obtained using the kit (100) of components of the invention is illustrated in figures from 5A to 5D, and comprises a first common component (1) realised as described in the foregoing, and a unit (2) of second components (20, 21) that are interchangeable with one another, as previously mentioned, which are assemblable and couplable to the first common component (1).

The first common component serves to anchor and mount the supporting structure of the weighing apparatus, while the unit of interchangeable second components (hollow box body, hatch) concur in forming the receptacle for receiving the products once mounted and assembled on the frame of the first common component.

1. Kit of components for forming an interchangeable batching/weighing hopper for batching/weighing products in a combined weighing apparatus, comprising a first common component, mountable on a supporting structure of a combined weighing apparatus, and at least one unit of interchangeable second components which are assemblable and mountable to the first common component to form the hopper,
wherein the first common component comprises:
a frame shaped in such a way to define a seat;
at least one coupling and fixing member mounted on the frame, for mounting and anchoring the frame to a portion of the supporting structure of the combined weighing apparatus;
at least one movable element articulated to the frame according to an axis of articulation transverse to the seat;
a driving mechanism for rotational actuation of the movable element about the respective axis of articulation comprising an actuation lever having an end that is configured to be couplable to, and operable by, a respective actuating member mounted on the supporting structure of the weighing apparatus;
wherein the unit of interchangeable second components comprises:
a hollow box body having an upper opening and a lower opening, shaped and dimensioned in such a way as to be able to enter within the seat of the frame;
at least one hatch shaped in such a way as to be able to occlude the lower opening of the hollow box body, when the driving mechanism activates the movable element in rotation about the respective axis of articulation in a first direction of rotation, and in such a way as to open the lower opening of the hollow box body when the driving mechanism rotates the movable element around the respective axis of articulation in a second direction of rotation
the kit being characterised in that the hollow box body comprises at least one hooking element which is conformed so as to couple removably with at least one support element of the frame, in such a way as to maintain the hollow box body positioned stably in the seat of the frame, and in that the at least one hatch is configured and dimensioned to couple via the hooking means removably to the at least one movable element articulated to the frame.

2. Kit of components as claimed in claim 1, wherein the at least one support member mounted on the frame is constituted by a first bar mounted on a facing first pair of arms, and wherein the at least one hooking element of the hollow box body comprises at least one bracket having an end shaped so as to be removably coupled with the first bar.

3. Kit of components as in claim 1, wherein the hooking means for removably attaching the at least one hatch to the at least one movable element articulated to the frame of the first common component comprise at least one through-hole made in the movable element and at least one tang element protruding externally from the hatch, the tang element being dimensioned and shaped to enter within the through-hole of the movable element in such a way as to enable a removable coupling between the at least one hatch and the at least one movable element of the frame.

4. Kit of components as claimed in claim 1, wherein the driving mechanism for rotational actuation of the movable element about the respective axis of articulation comprises: a first arm connected at one end to the axis of articulation of the movable element;
and a second arm articulated to the first arm and articulated by means of a roller to the actuation lever, wherein the roller is sliding within a sliding slot formed in a portion of the frame of the first common component.

5. Kit of components as claimed in claim 1, wherein the at least one coupling and fixing member of the first universal component for mounting and anchoring the frame to a portion of the supporting structure of the combined weighing apparatus is constituted by a second bar mounted between a second pair of arms of the frame of the first common component.

6. Kit of components as claimed in claim 1, wherein the unit of interchangeable second components to be coupled and assembled to the first common component can be selected from at least two units of second components, wherein a first unit of second components comprises a first hollow box body with a respective first hooking element and a second unit of second components comprising a second hollow box body with a respective second hooking element, the first and second hollow box body being dimensioned in such a way as to have respectively a predetermined first and a second capacity different to one another, the first and second hollow box body being enterable within the seat of the frame of the first common component so that the respective first or second hooking element removably couples with the support element of the frame, and wherein at least one respective first or second hatch dimensioned so as to be able to respectively occlude or open the lower opening of the second hollow box body is coupled to the movable element of the frame of the first common component.

7. Kit of components as claimed in claim 6, wherein the first and second hooking element are configured and dimensioned so as to couple alternatively and removably with at least one support element of the frame in a same point.

8. Batching/weighing hopper for batching/weighing products in a combined weighing apparatus obtained by means of a kit of components comprising a first common component and a unit of second components that are interchangeable, assemblable and couplable to the first common component as claimed in claim 1.
